(19) United States
(12) Patent Application Publication
(10) Pub. No.: US 2023/0162163 A1
(43) Pub. Date: May 25, 2023

(54) SYSTEM AND METHOD FOR DETERMINING ENVIRONMENTAL FOOTPRINT

(71) Applicant: OKEANOS GROUP, LLC, Miami Beach, FL (US)

(72) Inventor: Florencio Gomez Cuetara, Miami Beach, FL (US)

(21) Appl. No.: 17/993,509

(22) Filed: Nov. 23, 2022

Related U.S. Application Data
(60) Provisional application No. 63/283,081, filed on Nov. 24, 2021.

(51) Int. Cl. G06Q 10/30; G06Q 30/0242

(52) U.S. Cl. CPC G06Q 10/30; G06Q 30/0242

(57) ABSTRACT

System and method for determining environmental footprint for a product or packaging includes: receiving information from a user scanning a code on the product or packaging, where the received information includes time of the scan, geolocation of the user, user's language and information about the product or packaging; calculating a baseline emissions by quantifying an amount of conventional plastic production that has been avoided by considering product or packaging weight and density; adjusting the environmental footprint based on product or packaging weight and density; adjusting the environmental footprint based on location of where the product was acquired; factoring in carbon footprint of the transporting the product or packaging from an origination location to the location of where the product was acquired; and generating an environmental footprint report for transmission to the user, wherein the report includes environmental benefits generated as a result of purchasing the product using plastic alternative material.

### CROSS-REFERENCE TO RELATED APPLICATIONS

This patent application claims the benefits of U.S. Provisional Patent Application Ser. No. 63/283,081, filed on Nov. 24, 2021, and entitled “System and Method for Localized Lifecycle Determination,” the entire content of which is hereby expressly incorporated by reference.

### FIELD OF THE INVENTION

The disclosed invention generally relates to environmentally friendly packaging and more specifically to calculating environmental footprint, for example, carbon footprint savings, and a system that provides consumers with lifecycle analysis information.

### BACKGROUND

The packaging industry has evolved significantly over the years. There used to be a time where users had no way of knowing the ingredients of the purchased product, but packaging now includes all kinds of useful information for consumers. With environmental concerns being brought to the public forefront, packaging that conveys its environmental footprint seems like the next logical evolution in the packaging industry.

However, no entity has yet been able to develop a system for delivering this information to consumers, and for good reason; the technical challenges in developing such a process are enormous. For one, developing a methodology that can calculate environmental footprint is difficult as numerous variables affect packaging's footprint, ranging from the origin of the packaging's materials, country specific transportation and lifecycle analysis data, the recipe of the packaging, etc. Providing packaging footprint data to the consumer also involves compiling and maintaining several databases of country specific data. With many user-specific, product specific, and country specific variables, it also is impractical, if not impossible to print this information directly on the package, for instance, nutrition facts. Finally, to maximize the positive environmental impact of sustainable packaging, it's important to provide users with personalized data such as advertisements to encourage continued purchases of products using sustainable packaging, as well as informing users of optimal disposal options.

### SUMMARY

Made-from-stone packaging provides significant environmental benefits. Rather than having to rely on consumers to dispose of packaging properly, made-from-stone packaging reduces plastic at the source, by replacing traditional plastics such as polypropylene, polystyrene, and polyethylene, with calcium carbonate. It is renewable, widely abundant, and can be sourced from all around the world. By mixing calcium carbonate with a small amount of plastic, and by locally sourcing materials, made-from-stone packaging generates a significant reduction in carbon footprint, water footprint, and plastic pollution.

In some embodiments, the present disclosure is a methodology and process executing on one or more for calculating environmental footprints and provides lifecycle analysis information, including conveying the environmental footprint realized as a result of purchasing a product, such as a product with made-from-stone packaging.

In some embodiments, the present disclosure is method executed on one or more computers for determining environmental footprint for a product or packaging using plastic alternative material. The method includes: receiving information from a user scanning a code on the product or packaging, wherein the received information includes time of the scan, geolocation of the user, user's language and information about the product or packaging; calculating a baseline emissions by quantifying an amount of conventional plastic production that has been avoided by using alternative material for the product or packaging by considering product or packaging weight and density; adjusting the environmental footprint based on product or packaging weight and density relative to weight and density of a plastic alternative; adjusting the environmental footprint based on location of where the product was acquired; factoring in carbon footprint of the transporting the product or packaging from an origination location to the location of where the product was acquired; and generating an environmental footprint report for transmission to the user, wherein the report includes environmental benefits generated as a result of purchasing the product using plastic alternative material.

In some embodiments, the present disclosure is system for determining environmental footprint for a product or packaging using plastic alternative material. The system includes: a receiving port for receiving information from a user scanning a code on the product or packaging, wherein the received information includes time of the scan, geolocation of the user, user's language and information about the product or packaging; and one or more computers for calculating a baseline emissions by quantifying an amount of conventional plastic production that has been avoided by using alternative material for the product or packaging by considering product or packaging weight and density; adjusting the environmental footprint based on product or packaging weight and density relative to weight and density of a plastic alternative; adjusting the environmental footprint based on location of where the product was acquired; factoring in carbon footprint of the transporting the product or packaging from an origination location to the location of where the product was acquired; and generating an environmental footprint report for transmission to the user, wherein the report includes environmental benefits generated as a result of purchasing the product using plastic alternative material.

In some embodiments, the present disclosure is a non-transitory tangible storage medium for storing a plurality of computer instructions, the computer instructions when executed by one or more computers performing a method for determining environmental footprint for a product or packaging using plastic alternative material. The method includes: receiving information from a user scanning a code on the product or packaging, wherein the received information includes time of the scan, geolocation of the user, user's language and information about the product or packaging; calculating a baseline emissions by quantifying an amount of conventional plastic production that has been avoided by using alternative material for the product or packaging by considering product or packaging weight and density; adjusting the environmental footprint based on product or packaging weight and density relative to weight and density of a plastic alternative; adjusting the environmental footprint based on location of where the product was acquired; and factoring in carbon footprint of the transporting the product or packaging from an origination location to the location of where the product was acquired;

generating an environmental footprint report for transmission to the user, wherein the report includes environmental benefits generated as a result of purchasing the product using plastic alternative material.

### BRIEF DESCRIPTION OF THE DRAWINGS

A more complete appreciation of the disclosed invention, and many of the attendant features and aspects thereof, will become more readily apparent as the disclosed invention becomes better understood by reference to the following detailed description when considered in conjunction with the accompanying drawings in which like reference symbols indicate like components.

FIGS. 1A and 1B show exemplary screenshots of a generated report, according to some embodiments of the present disclosure.

FIG. 2 is an exemplary process flow, according to some embodiments of the present disclosure.

FIG. 3 illustrates an example of input data for the density adjustment factor, according to some embodiments of the present disclosure.

FIG. 4 shows various carbon dioxide (CO2) footprints for different types of transportation vehicles, according to some embodiments of the present disclosure.

FIG. 5 is an exemplary process flow for determining an environmental footprint, according to some embodiments of the present disclosure.

### DETAILED DESCRIPTION

In some embodiments, the present disclosure is a methodology and process executing on one or more for calculating environmental footprints, for example, carbon footprint, and a system that provides consumers with lifecycle analysis information, including conveying the footprint realized as a result of purchasing a product, such as a product with made-from-stone packaging. In some embodiments, when a user scans a Quick Response (QR) code located on the packaging of a product, the system calculates an environmental footprint of the packaging using various algorithms and determines a footprint for the packaging and reports the results with lifecycle analysis information. Stone as used here include not only stones or rocks, but also, any naturally occurring solid mass or aggregate of minerals or mineraloid matter form the Earth's outer solid layer.

In some embodiments, a consumer downloads an application on their computer or mobile device. When the consumer buys or obtain a product, they scan the QR on the product (or its packaging) and receive a report about the carbon (and water) footprint of the products and/or its packaging. The consumer may register on a website as a member or invoke the application (process) as a guest. Environmental footprints may include carbon footprint, other greenhouse gas footprint and/or water footprint.

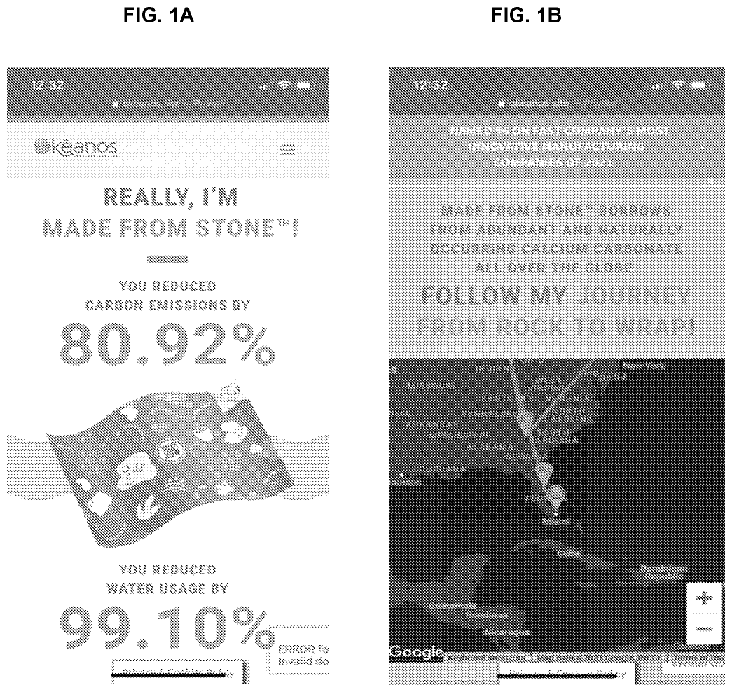

FIGS. 1A and 1B show exemplary screenshots of a generated report, according to some embodiments of the present disclosure. FIG. 1A shows an exemplary report for the carbon and water footprint generated as a result of using Made from stone packaging. These environmental footprints are calculated by comparing the known footprint of traditional plastics with Made from stone packaging, the formula for which will be described below. FIG. 1B illustrates a journey from calcium carbonate to the packaging of a product, as a result of QR scanning of the packaging. In some embodiments, the report may include consumer advertising that offers consumers a link to explore other made from stone products as well as allowing them to discover how the environmental footprints were generated, by clicking on the center circle. In some embodiments, the report provides links to various philanthropic efforts and advertisement that invites users to join a network of influencers or advertisers.

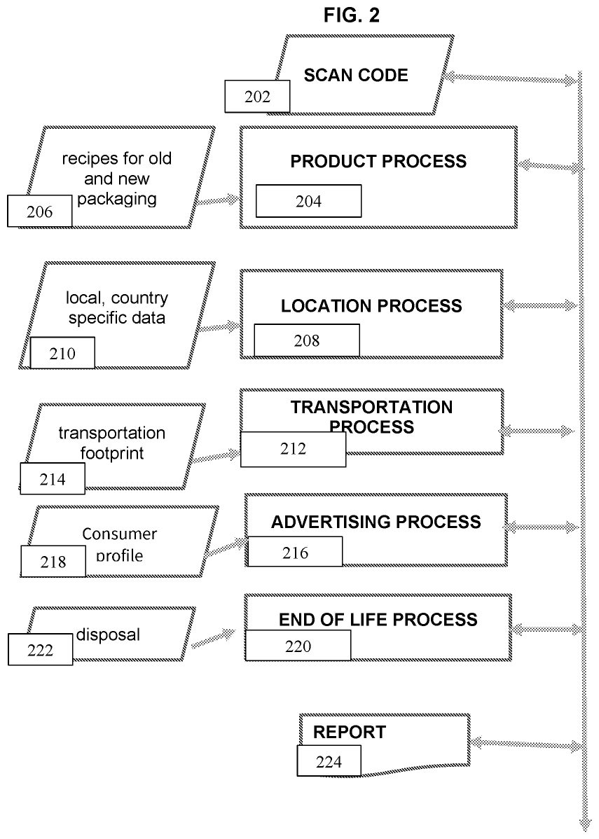

FIG. 2 is an exemplary process flow, according to some embodiments of the present disclosure. In some embodiments, the methodology calculates user-specific lifecycle analysis and environmental footprint savings when using plastic alternatives instead of conventional plastic. As shown in FIG. 2, the process, at block 202, takes information generated at the time of the QR scan, such as, the user's location, language, and operating system found, and converts the information into a customized lifecycle analysis report, for example, similar to the report shown in FIG. 1A. The report, including environmental footprint and/or percentage of reduction in carbon emissions and water usage for the packaging, is then displayed to the consumer. The report may also include a map (e.g., similar to the map in FIG. 1B) displaying the origins of the plastic alternative material(s) (for example, calcium carbonate), as it can be sourced from all over the world, its journey (and/or travel path) from stone to packaging, which is important as transportation and locally sourcing materials has an impact on total environmental footprint, customized disposal solutions and advertising, as well as ads linking to philanthropic efforts. For example, the report may show where the plastic alternative (e.g., stone) was mined, processed, transported, manufactured as packaging for a product, and where the product travelled until it reached the consumer.

In some embodiments, a user, registered with an application (e.g., a website) scans the QR code on a product or its packaging. Information such, as the time of the scan, IP Address and Geolocation of the user, operating system of user's device (e.g., a smart phone), user's language (for example, the language used on the packing), the product that user scanned, and a user ID (for repeat users) is saved in a database. In some embodiments, the Geolocation of the user is determined automatically via a GPS device or other location determining processes, such as triangularization of time of arrival from the user's device.

This information is then utilized in various processes/algorithms that also reference data pulled from various databases. Examples of various information that are generated after the QR scan may include customer location, customer age, customer gender, customer operating system, and customer browser type.

The methodology calculates user-specific lifecycle analysis and environmental footprints (including environmental footprint savings) when using plastic alternatives instead of conventional plastic. As shown in block 204, the process analyzes product factors that affect environmental footprint. The process considers the product that the user scanned and compares the recipes of plastic alternative versus conventional plastic. In some embodiments, the process calculates CO2 and H2O footprint (and/or footprint savings), which factors in formulation comparison (comparing previous packaging type to plastic alternatives packaging), product weight and density, utilizing information in a database 206. Database 206 contains recipes for old and new packaging. In some embodiments, database 206 is automatically revised and updated based on its usage and new information available, using machine learning or artificial intelligence technologies. In some embodiments, the process considers the product that the user scanned and compares the recipes of plastic alternative versus conventional plastic packaging. In some embodiments, the process uses the following equation for the comparison:

1−((N+(D*T)/(P+(D*T))) Eq. (1)

where P is the baseline product carbon (or water) footprint, N is the plastic alternative carbon (or water) footprint, D is the distance that the product/packaging travelled from its origin to the point of purchase, and T is a transportation factor, in miles or kilometer. Variable T is a localized transportation factor that represents the greenhouse gas emission and/or water usage per kilometer traveled. Localized means that this variable accounts for differences in footprint emissions when transporting in once country versus another. Meanwhile, D is the distance in kilometers that the product has traveled. Multiplying D and T will result in the total footprint emissions of transporting the product.

Referring back to FIG. 2, in block 208, the process considers product material origin and country specific lifecycle analysis to calculate the environmental footprint, using information in a database 210. Database 210 contains local, country specific data. For example, a kilowatt of energy in France may have a lower carbon footprint in the U.S. In some embodiments, the process considers material origin and country specific lifecycle analysis.

In some embodiments, baseline emissions are determined by quantifying the amount of conventional plastic production that has been avoided through the manufacturing and sale of plastic substitute using alternative materials. In the quantification, a product developer determines the quantity of the alternative material and assumes that it displaces a specific conventional plastic polymer, such as polyethylene. In some embodiments, the base line is calculated by the following equation:

BE_{tp,y}=Σi(Q_{Am,y}*DAFᵢEFᵢ) (2)

Here, BEtp,y represents the baseline emissions from traditional plastic manufacturing in time period y. QÆM,y represents the net quantity of alternative material in metric tons produced by the project in year y that is used to produce a plastic substitute. This quantity does not include traditional plastics that are blended with the alternative material, and DAFI represents the density adjustment factor for plastic type i.

In some cases, an alternative packaging/product may be heavier or denser (or less heavy or less dense) compared to the type of material it is displacing. If the alternative material is heavier that the plastic it is displacing, then the level of carbon saving is adjusted (lowered), and vice versa. The density adjustment (DAF) can be determined using the following equation:

$${DAF}_{i} = \frac{{WO}_{i}}{{WAP}_{i}} \qquad ( 3 )$$

where:
WOᵢ=Weight in grams of a representative sample of the original plastic type i

WAPᵢ=Weight in grams of a representative sample of the alternative product, replacing plastic type i, EFI represents the emission factor associated with the production of conventional plastic materials, measured in tCO2e/metric ton of plastic for plastic type i. Table 1 below shows emissions factors for the different types of plastic, which are substituted into variable “i” in the baseline formula in Equation (2) above. The different letterings in Table 1 correspond to different traditional plastic types, which have different emission footprints. The output of this formula then serves as variable P in the overall comparison formulation. Meanwhile, the emission factor for plastic packaging alternative (e.g., made-from-stone) is found and is substituted into variable N in the overall comparison formulation.

TABLE 1

| | Emission Factor (tCO₂e/metric ton of |
|---|---|
| Plastic Type | plastic material produced) |
| HDPE | 1.41 |
| LDPE | 1.77 |
| PET | 2.30 |
| LLDPE | 1.53 |
| PP | 1.52 |
| PS | 2.55 |
| PVC | 2.02 |
| ABS | 3.25 |
| TPU | 2.49 |
| PC | 2.49 |

Table 2 below shows exemplary data structures stored in a database for plastic alternatives and includes footprints corresponding to different types of stone. Also, overall environmental impacts for each calcium carbonate product (per dry ton of product)

TABLE 2

| | Unit (per | Screened | Coarse Dry | Coarse Dry | Fine Slurry | Fine Slurry |
|---|---|---|---|---|---|---|
| Impact Category | dry ton) | Grade | 30 μg | 20 μg | 3 μg | 3 μg |
| Global Warming | kg CO₂ eq | 2.24E+01 | 3.11E+01 | 5.22E+01 | 1.83E+02 | 2.69E+02 |
| Fossil Fuel Depletion | MJ surplus | 2.29E+01 | 3.36E+01 | 6.12E+01 | 1.64E+02 | 2.22E+02 |
| Eutrophication | kg N eq | 2.80E−02 | 2.45E−02 | 3.81E−02 | 8.30E−02 | 1.83E−01 |
| Smog | kg O₃ eq | 9.74E+00 | 8.83E+00 | 1.54E+01 | 2.49E+01 | 2.98E+01 |
| Acidification | kg SO₂ eq | 4.72E−01 | 4.64E−01 | 7.41E−01 | 1.90E+00 | 2.58E+00 |
| Ozone Depletion | kg CFC₋₁₁ eq | 2.66E−07 | 2.89E−07 | 3.04E−07 | 1.05E−06 | 2.53E−06 |
| Carcinogenics | CTUₕ | 3.91E−07 | 3.68E−07 | 6.07E−07 | 1.28E−06 | 2.38E−06 |
| Non-carcinogenics | CTUₕ | 1.77E−06 | 2.44E−06 | 4.33E−06 | 1.03E−05 | 1.24E−05 |
| Respiratory Effects | kg PM_{2.5} eq | 1.91E−02 | 1.82E−02 | 2.67E−02 | 8.54E−02 | 1.58E−01 |
| Ecotoxicity | CTU_{E} | 3.64E+01 | 5.16E+01 | 8.64E+01 | 1.85E+02 | 3.22E+02 |
| Cumulative Energy | MJ | 3.12E+02 | 4.33E+02 | 7.27E+02 | 2.66E+03 | 4.36E+03 |
| Demand | | | | | | |

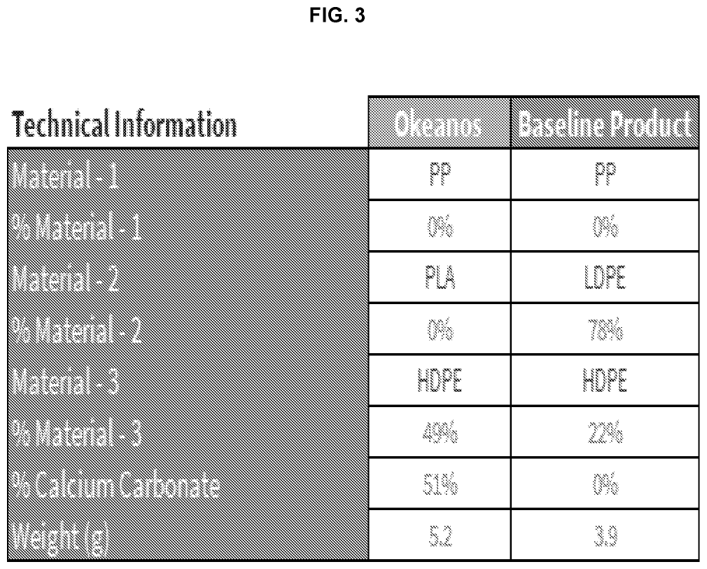

The recipes affect environmental footprint analysis in different ways. For example, waste incineration factors into a product's footprint because incinerating conventional plastics and plastic alternatives release carbon dioxide (CO2) into the atmosphere at different rates. Comparing the density and weight of the plastic alternative to conventional plastic also factors into environmental footprint analysis because higher weight/density reduces the level of CO2 footprint, and vice versa. Density is factored into the product-based calculation using the density adjustment calculation found in Equation (3). An example of input data for the density adjustment factor is shown in FIG. 3, where the product weights shown are substituted into the density adjustment formula to adjust the percentage of the footprint. FIG. 3 compares formulation of the traditional plastic product (the baseline product) and the plastic alternative. For example, the chart outlines that the traditional plastic product, in this case, a plastic water cup, contains 78% of low density polyethylene (LDPE) and 22% of high density polyethylene (HDPE). Meanwhile, the water cup for the alternative packing contains 0% LDPE and 49% of HDPE.

Referring back to FIG. 2, in some embodiments, the process in block 208 adds to the overall environmental footprint analysis by factoring in location; that is country specific lifecycle analysis and material origin. For example, going back to incineration, countries incinerate waste at different rates. An exemplary table of country specific incineration rates is shown in Table 3 below. Country specific incineration rates will increase or decrease the environmental footprint depending on the customer's location, as the country where the customer is located will be the country where the product is ultimately disposed. The material's origin also factors into the analysis. For example, France has a lower carbon footprint per kilowatt of energy than the US, so depending on the country of manufacture, the footprint changes. Both manufacturing plants that produce conventional plastics and plastic alternatives are powered by fossil fuels, but the amount of energy required to produce each, and in turn greenhouse gas emissions, can differ. The methodology compares the greenhouse gas emissions from these two types of facilities.

TABLE 3

| Country | Incineration Percent |
|---|---|
| Andorra | 52.10 |
| Australia | 9.77 |
| Austria | 37.90 |
| Belgium | 43.39 |
| Bulgaria | 2.75 |
| Bermuda | 67.60 |
| Canada | 3.00 |
| Switzerland | 47.00 |
| Channel Islands | 16.44 |
| Chile | 0.14 |
| China | 29.84 |

In some embodiments, the process in block 212 factors transportation into the overall environmental footprint analysis and provides variables T and D in the footprint savings of Equation (1). This process pulls data from a locally approved transportation footprint database 214 to factor the user's geolocation into account, as transporting in different countries to deliver the product to user has different carbon footprints. In some embodiments, the process also keeps track of distribution points to produce a map in the reporting that shows users the packaging's journey from stone to product, as shown in FIG. 1B. The map may show the materials source origin, where it became the compound that is then converted into bags, containers, and other functional packaging, all the way to the store where the user purchased the product.

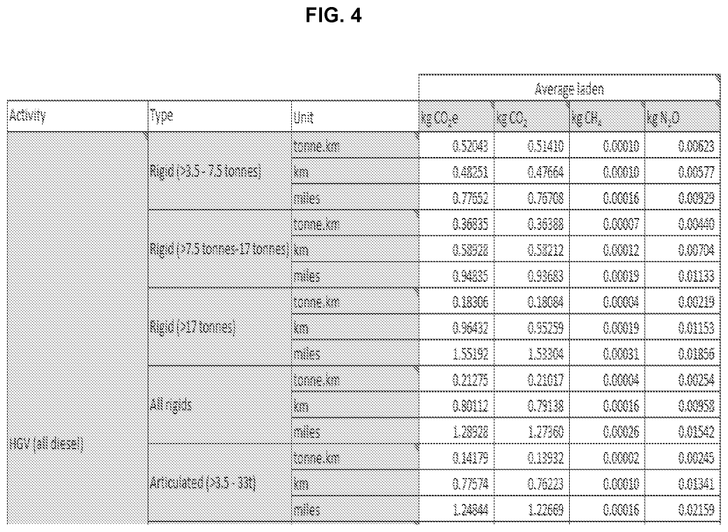

The mode of transportation may also play a role in the footprint calculation. FIG. 4 depicts an exemplary table stored in a database (e.g., database 214 in FIG. 2) for the transportation footprint. FIG. 4 shows various CO2 footprints for different types of transportation vehicles. This burden is substituted for variable T in the footprint comparison formula and is then multiplied by the distance that the packaging traveled, variable D, which is found, for example, using a Google API™. By locally sourcing materials, CO2 footprint is reduced by decreasing distance and transportation emissions.

In some embodiments, the process in block 216 analyses user data to tailor advertising by taking into account the number of times user scanned the product/package, user's location, and the types of products user typically purchases. Rather than focusing on savings calculations, the advertising algorithm in block 216 designs and transmits user specific ads and philanthropy messaging. For example, if the user repeatedly purchases a specific product, rice for example, the algorithm takes note and suggests that the user buy another type of rice also utilizing made-from-stone packaging.

In some embodiments, the process in block 216 relies on many of the inputs generated at time of customer scan. For example, a customer's location can affect what philanthropic efforts are shown on the advertising screen, as there can be specific efforts going on in the customer's location. In addition, individualized customer data will be useful to target specific ads related to plastic alternative products.

Table 4 below shows exemplary information for customer specific scan data. For example, since customer “0221378” has scanned 4 times, the process recognizes that this customer is likely to purchase and scan today, and will look at prior purchased products, such as Rice Packets, to curate suggestions to that customer.

TABLE 4

| | Customer | | Repeat | Number of |
|---|---|---|---|---|
| Customer ID | Location | Product Type | Customer? | Times Scanned |
| 0221378 | Bogota, | Grocery Bag | Yes | 4 |
| | Colombia | | | |
| 0221379 | Mumbai, | Rice Packet | Yes | 2 |
| | India | | | |
| 0221380 | Miami, USA | Rice Packet | No | 1 |
| 0221381 | Bratislava, | Grocery Bag | Yes | 3 |
| | Slovakia | | | |
| 0221382 | Cincinnati, | Grocery Bag | No | 1 |
| | USA | | | |

In some embodiments, the end-of-life algorithm in block 220 uses inputs to convey to consumer best disposal options by using their location and a database 222. For example, some regions may not be able to compost, some regions may not have nearby recycling, etc. The process utilizes a user's geolocation and a database of localized product disposal options 222 to tell users how they can best dispose of their product.

For example, perhaps a user in one location does not have nearby access to recycling, but their region is suitable for composting, the process produces an output telling the user to compost their packaging. On the other hand, if there are recycling options, but no composting, the process will instead tell the user to recycle the product.

Although databases 206, 210, 214, 218 and 22 are depicted as separate databases, one skilled in the art would readily recognize that some or all of the databases may be combined into one data base. Also, each database may reside on one or more computers in different locations, connected via a computer network such as the Internet or local area networks. Similarly, the processes in blocks 202, 204, 208, 212, 216 and 220 may be executed on one or more computers connected via a computer network such as the Internet or local area networks. For example, the scanning in block 202 may be executed on a user's smart phone or a mobile device, while process 204 may be executed by a first server located in location X and process 206 may be executed by a second server located in location Y, and so on. Additionally, computer instructions for the process of the disclosures may be stored on a tangible storage medium, such as a computer memory or a memory device, so that when executed by one or more computer, the process is performed.

An output/report is then generated and displayed, in block 224. In some embodiments, the report includes a life cycle analysis page, where consumer can view the environmental benefit generated as a result of purchasing a product made with or a packaging with plastic-alternative. The report may also include data and information such as CO2 relative reduction, water reduction, nutrification, acidification, product route, custom advertisements, philanthropy information, and/or customized product disposal solutions.

It is also noted that the present disclosure uses product or product packaging interchangeably for the purpose of determining the environmental footprint of the product or the packaging. However, it is understood that in some cases the product itself may be using plastic alternative material(s), while in other cases the packing may use plastic alternative material, such as stone.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended drawings.

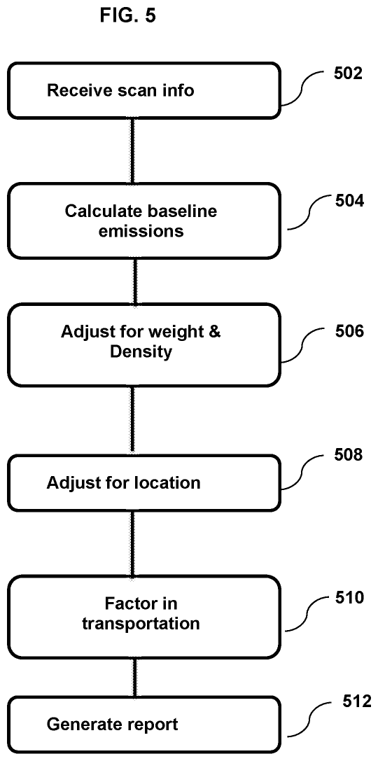

FIG. 5 is an exemplary process flow for determining an environmental footprint saving, according to some embodiments of the present disclosure. As shown in block 502, one or more server computers (having a receiving port) receive information from a user having a mobile device scanning a code on the product or packaging, via a computer communication network. In some embodiments, the received information includes time of the scan, geolocation of the user, user's language and information about the product or packaging. The location of the user (mobile device) may be automatically determined by the server. In block 504, a baseline emissions is calculated by quantifying an amount of conventional plastic production that has been avoided by using alternative material for the product or packaging by considering product or packaging weight and density.

In block 506, the environmental footprint saving is adjusted based on product or packaging weight and density is adjusted relative to weight and density of a plastic alternative. In some cases, an alternative packaging/product may be heavier or denser (or less heavy or less dense) compared to the type of material it is displacing. If the alternative material is heavier that the plastic it is displacing, then the level of carbon saving is adjusted (lowered), and vice versa. In block 508, the environmental footprint saving is adjusted based on the location of the place where the product was acquired. Transporting to deliver the product to a purchasing user has different carbon footprints, depending on difference locations. Environmental footprints may include carbon footprint, other greenhouse gas footprint and/or water footprint.

The carbon footprint of the transporting the product or packaging from an origination location to the location of where the product was acquired is also factored in for determining an environmental footprint saving, in block 510. A report is then generated, in block 224. The report is transmitted to the user over a computer network to be displayed on the user's mobile device. In some embodiments, the report includes a life cycle analysis page, where consumer can view the environmental benefit generated as a result of purchasing a product made with or a packaging with plastic-alternative. The report may also include data and information such as carbon dioxide relative reduction, water reduction, nutrification, acidification, product route, custom advertisements, philanthropy information, and/or customized product disposal solutions.

It will be recognized by those skilled in the art that various modifications may be made to the illustrated and other embodiments of the filter and filtering method described above, without departing from the broad inventive scope thereof. It will be understood therefore that the disclosure is not limited to the particular embodiments or arrangements disclosed, but is rather intended to cover any changes, adaptations or modifications which are within the scope of the disclosure as defined by the appended claims and drawings.

1. A method executed on one or more computers for determining environmental footprint for a product or packaging using plastic alternative material, the method comprising:
receiving information from a user scanning a code on the product or packaging, wherein the received information includes time of the scan, geolocation of the user, user's language and information about the product or packaging;
calculating a baseline emissions by quantifying an amount of conventional plastic production that has been avoided by using alternative material for the product or packaging by considering product or packaging weight and density;
adjusting the environmental footprint based on product or packaging weight and density relative to weight and density of a plastic alternative;
adjusting the environmental footprint based on location of where the product was acquired;
factoring in carbon footprint of the transporting the product or packaging from an origination location to the location of where the product was acquired; and
generating an environmental footprint report for transmission to the user, wherein the report includes environmental benefits generated as a result of purchasing the product using plastic alternative material.

2. The method of claim 1, further comprising determining best disposal options for the product or packaging utilizing the geolocation of the user.

3. The method of claim 1, wherein the report further includes a map of an origin of the plastic alternative material and the origination location to the location of where the product was acquired, customized disposal solutions and advertising.

4. The method of claim 1, wherein the report further includes water reduction, nutrification, acidification and product travel route.

5. The method of claim 1, wherein the adjusting the environmental footprint based on product or packaging weight and density utilizes the following equation:
$${DAF}_{i} = \frac{{WO}_{i}}{{WAP}_{i}} \qquad ( 3 )$$
where, DAFᵢ is density adjustment for an original plastic type I, WO is weight in grams of a representative sample of the original plastic type i, and WAPᵢ is weight in grams of the alternative product, replacing plastic type i.

6. The method of claim 1, further comprising comparing plastic alternative material with conventional plastic packaging and include said comparison in the report.

7. The method of claim 6, wherein the comparing plastic alternativematerial with conventional plastic packaging utilizes the following equation:
1−((N+(D*T)/(P+(D*T))) Eq. (1)
where P is a baseline product carbon or water) footprint, N is a plastic alternative carbon or water footprint, D is a distance that the product or packaging travelled from its origin to a point of purchase, T is a transportation factor, in miles or kilometer, and D is a distance in kilometers that the product has traveled.

8. The method of claim 1, further comprising calculating carbon dioxide and water footprint for using the plastic alternative material.

9. The method of claim 1, further comprising increasing or decreasing the environmental footprint based on incineration rates of the product or packaging at the location where the product was acquired.

10. The method of claim 1, wherein the environmental footprints includes carbon footprint, other greenhouse gas footprint and/or water footprint.

11. The method of claim 1, wherein the plastic alternative material includes stone, or aggregate of minerals or mineraloid matter form the Earth.

12. A system for determining environmental footprint for a product or packaging using plastic alternative material comprising:
a receiving port for receiving information from a user scanning a code on the product or packaging, wherein the received information includes time of the scan, geolocation of the user, user's language and information about the product or packaging; and
one or more computers for
calculating a baseline emissions by quantifying an amount of conventional plastic production that has been avoided by using alternative material for the product or packaging by considering product or packaging weight and density;
adjusting the environmental footprint based on product or packaging weight and density relative to weight and density of a plastic alternative;
adjusting the environmental footprint based on location of where the product was acquired;
factoring in carbon footprint of the transporting the product or packaging from an origination location to the location of where the product was acquired; and
generating an environmental footprint report for transmission to the user, wherein the report includes environmental benefits generated as a result of purchasing the product using plastic alternative material.

13. The system of claim 12, further comprising determining best disposal options for the product or packaging utilizing the geolocation of the user.

14. The system of claim 12, wherein the report further includes a map of an origin of the plastic alternative material and the origination location to the location of where the product was acquired, customized disposal solutions and advertising.

15. The system of claim 12, wherein the report further includes water reduction, nutrification, acidification and product travel route.

16. The system of claim 12, further comprising increasing or decreasing the environmental footprint based on incineration rates of the product or packaging at the location where the product was acquired.

17. The system of claim 12, wherein the environmental footprints includes carbon footprint, other greenhouse gas footprint and/or water footprint.

18. The system of claim 12, wherein the plastic alternative material includes stone, or aggregate of minerals or mineraloid matter form the Earth.

19. A non-transitory tangible storage medium for storing a plurality of computer instructions, the computer instructions when executed by one or more computers performing a method for determining environmental footprint for a product or packaging using plastic alternative material, the method comprising:
receiving information from a user scanning a code on the product or packaging, wherein the received information includes time of the scan, geolocation of the user, user's language and information about the product or packaging;
calculating a baseline emissions by quantifying an amount of conventional plastic production that has been avoided by using alternative material for the product or packaging by considering product or packaging weight and density;
adjusting the environmental footprint based on product or packaging weight and density relative to weight and density of a plastic alternative;
adjusting the environmental footprint based on location of where the product was acquired; and
factoring in carbon footprint of the transporting the product or packaging from an origination location to the location of where the product was acquired;
generating an environmental footprint report for transmission to the user, wherein the report includes environmental benefits generated as a result of purchasing the product using plastic alternative material.

20. The non-transitory tangible storage medium of claim 19, wherein the environmental footprints includes carbon footprint, other greenhouse gas footprint and/or water footprint.
